(19) United States
(12) Patent Application Publication
(10) Pub. No.: US 2026/0080417 A1
(43) Pub. Date: Mar. 19, 2026

(54) Digital System Development Lifecycle

(71) Applicants: Merck Sharp & Dohme LLC, Rahway, NJ (US); MSD Czech Republic s.r.o, Prague (CZ)

(72) Inventors: Kenroy Junior Wiliamson, Huntersville, NC (US); William Sonner Nicklin, Prague (CZ); Daniel G. Sodol Dziadiw, Montville, NJ (US)

(21) Appl. No.: 19/328,049

(22) Filed: Sep. 12, 2025

Related U.S. Application Data
(60) Provisional application No. 63/694,402, filed on Sep. 13, 2024.

(51) Int. Cl. G06Q 30/018; G06F 8/77

(52) U.S. Cl. CPC G06Q 30/018; G06F 8/77

(57) ABSTRACT

A digital system development lifecycle system processes approval requests for applications. The system generates a risk profile using a questionnaire and selects a set of deliverables based on the risk profile. The set of deliverables is tuned based on regulatory or enterprise policies. The system provides a user interface via which users can view progress towards the tuned set of deliverables.

### CROSS-REFERENCE TO RELATED APPLICATIONS

This Application claims the benefit of U.S. Provisional Patent Application No. 63/694,402, filed Sep. 13, 2024, which is incorporated by reference.

### BACKGROUND

### 1. Technical Field

The subject matter described relates generally to management of computer systems and, in particular, to providing automation within a system development lifecycle (SDLC) process.

### 2. Background Information

SDLC is an industry standard approach to developing quality systems using an identifiable, measurable, and repeatable process to ensure the information technology applications are compliant with applicable laws and regulations and fit for intended use. However, due to its complexity, it is not easy for SDLC practitioners to know if they are doing it right. Currently, the SDLC is a manual and very time-consuming process that often causes confusion and frustration for organizations to execute.

This is particularly true in heavily regulated industries such (e.g., life sciences) in which enterprises are typically required to develop and enforce exhaustive internal policies and procedures governing the development and use of IT applications. These regulatory and policy requirements typically mandate formal documentation to provide evidence that IT applications have been developed, deployed, and maintained in a controlled manner. Documents are used during audits and inspections to ensure that applications do not present risk to product quality, patient safety, or regulatory data integrity. Furthermore, the documentation itself must be maintained under adequate controls over its distribution, access, and use, not only for the life of the application but for the duration of retention periods set by regulatory bodies.

Not only is the execution of this documentation time-consuming, but simply understanding what is needed for a given IT application and aligning on an approach with business and quality stakeholders takes weeks or months. Often written in very dense legalese, internal policies and procedures often generate many questions and differing opinions, resulting in a large variety of independent manual implementations. Furthermore, as documentation is most often in an unstructured and manual “paper” format, organizations have limited insight into their own compliance posture and regulatory risk exposure. Consequently, it can often take months to sort through and complete the list of activities and documentation/evidence (referred to as “deliverables”) required by the SDLC process. This can cause delays, slow innovation, and make it harder for organizations to stay fully secure and compliant.

### SUMMARY

The above and other problems may be solved by a Digital SDLC system and process that eliminates the uncertainty of what is required to meet internal and external regulatory requirements for a given IT application. Acting as a trusted, single-source-of-truth, Digital SDLC can allow enterprises to focus on meeting operational needs quickly but with confidence that all applicable regulatory and policy requirements are met at the same time. Based on a technology asset and profile provided by a user, Digital SDLC determines a specific set of SDLC activities and IT controls that need to be in place to develop and deploy an IT application, aligned to the currently effective policies and procedures inside the enterprise, and external governmental regulations.

In addition to providing clear “how-to” guidance and status tracking, Digital SDLC can enable users to capture regulatory evidence of those activities in one place, eliminating or reducing the need for “paper” or separate electronic documentation. The automation capabilities and structured data approach can significantly improve both data quality and speed of execution by reducing the opportunity for manual error as well as accelerating the delivery of operational value and inspection readiness. By taking a ‘digital first’ approach, enterprises can leverage real-time data to proactively managing risk and compliance.

Furthermore, the system may also provide functionality via an application programming interface (API) or other suitable interface, enabling a continuous integration and continuous delivery (CI/CD) pipeline. Multiple integrations with other systems of records may also be provided to reduce or eliminate the need to manually copy information while enabling “guardrails”to ensure data quality and compliance.

By leveraging automation and prioritizing the user experience, Digital SDLC can remove guesswork and uncertainty for users, reduce or eliminate manual process steps, and provide a self-service platform for enterprises to easily manage their SDLC activities directly rather than outsource it. This can provide significant cost savings, reduction in cycle times, and a greatly improved compliance posture for the enterprise.

In one embodiment, a method implemented by a computing (e.g., SDLC) system for approving an application or system for deployment includes receiving an approval request for the application and determining a risk profile for the application based on user responses to a questionnaire. The method also includes selecting a set of deliverables from a plurality of possible deliverable steps based on the risk profile. The set of deliverables is tuned based on a policy and the tuned set of deliverables is provided for display to the user. In some embodiments, completed deliverables are submitted and automatically verified by the computing system. The application or system can be automatically deployed once all required deliverables are received and verified.

### BRIEF DESCRIPTION OF THE DRAWINGS

FIG. 1 is a block diagram of a networked computing environment including a Digital SDLC system, according to one embodiment.

FIG. 2 is a block diagram of the SDLC server of FIG. 1, according to one embodiment.

FIG. 3 is an example list of deliverables, according to one embodiment.

FIG. 4 is an example database schema flow, according to one embodiment.

FIG. 5 is an example user interface showing a Digital SDLC table of deliverables, according to one embodiment.

FIG. 6 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

Digital SDLC is a cloud-based digital compliance platform. The platform can provide an authoritative source for understanding, automating, and managing the SDLC activities required by an organization's internal policies and external regulations.

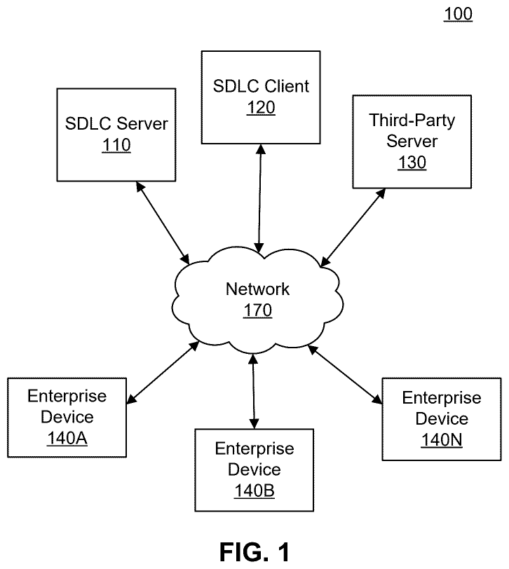

FIG. 1 illustrates one embodiment of a networked computing environment 100 including a Digital SDLC system. In the embodiment shown, the networked computing environment 100 includes a SDLC server 110, a SDLC client 120, a third-party server 130, and a set of one or more enterprise devices 140, all connected via a network 170. In other embodiments, the networked computing environment includes different or additional elements. In addition, the functions may be distributed among the elements in a different manner than described. For example, although the SDLC server 110 and SDLC client 120 are shown as separate components, the functionality of both may be provided by a single device.

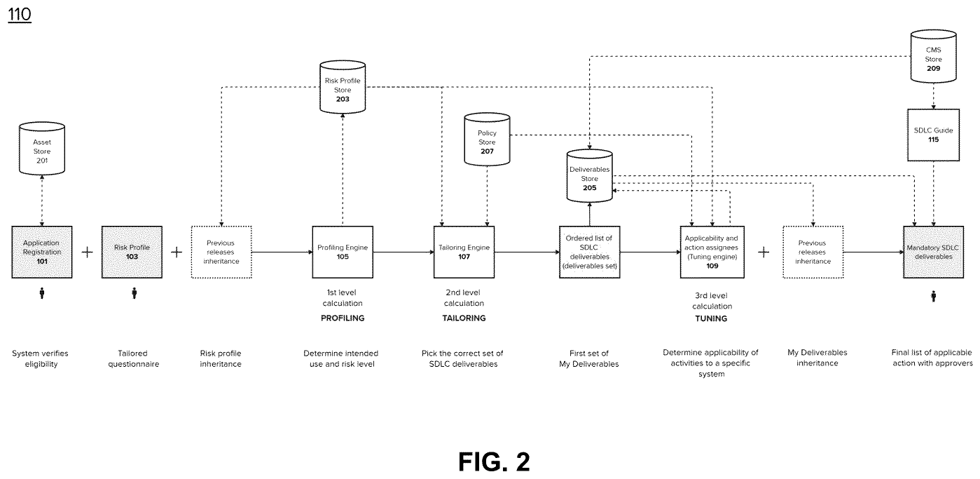

The SDLC server 110 is one or more computing devices that manage the Digital SDLC process. In one embodiment, the SDLC server 110 provides a web-based interface via which users can submit applications or systems for deployment (e.g., to enterprise devices 140) to be approved by the Digital SDLC process. Although the disclosure below generally refers to the approval of applications, it should be appreciated that the same or similar techniques may be applied for approving new systems for deployment in the networked computing environment 100. The SDLC server 110 analyzes submitted applications based on a questionnaire provided to the user to predict and generate a list of SDLC deliverables needed for approval of an application. The SDLC server 110 also enables the user to submit documentation and confirm completion of tasks and tracks progress towards approval of an application. Various embodiments of the Digital SDLC process are described in greater detail below, with reference to FIG. 2.

The SDLC client 120 is a computing device with which a user accesses the web-based interface provided by the SDLC server 110. In one embodiment, a user can interact with the SDLC server 110 using a web browser of the SDLC client 120. Using the web browser, the user submits an application for approval, reviews the generated listed of deliverables, compose the required evidence indicated in the list of deliverables generated by the SDLC server 110, and completes any other tasks required for SDLC approval of the application. Although only a single SDLC client 120 is shown, in practice, the networked computing environment 100 can include any number of such devices.

The third-party server 130 is one or more computing devices that provide information or services for completion of the Digital SDLC process. Example services include providing required employee training, authentication, security systems, and the like. A person having ordinary skill in the art would appreciate that there are a wide range of services that may be provided by third parties for completion of the Digital SDLC process and that use of such services may be preferable to using entirely enterprise-specific solutions. Although only one third-party server 130 is shown, in practice, the networked computing environment 100 can include any number of such devices.

The enterprise devices 140 are computing devices on which applications that are approved by the Digital SDLC process are deployed. Once an application has been approved, it may be automatically installed on one or more enterprise devices 140 or made available for installation on enterprise devices (e.g., via an application library). Although FIG. 1 includes three enterprise devices 140 (a first enterprise device 140A, a second enterprise device 140B, and an Nth enterprise device 140N), the networked computing environment may include any number of such devices (and will typically include many more).

The Digital SDLC process standardizes conventionally manual and subjective SDLC processes. Where conventional approaches can take months with outcomes and interpretations of requirements differing from team to team within an enterprise, Digital SDLC can provide rapid application approval according to objective rules derived from regulatory and policy requirements for the enterprise. Thus, Digital SDLC can reduce the risk of applications with security risks or other undesirable qualities being approved and deployed. In some cases, Digital SDLC may enable automated pushing of new or updated software to enterprise devices 140 without human approval while retaining confidence that the software is compliant with all applicable regulations and policies.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

### Example Systems

FIG. 2 illustrates one embodiment of the SDLC server 110. In the embodiment shown, the SDLC server 110 includes an application registration module 101, an asset store 201, a risk profile questionnaire module 103, a profiling engine 105, a risk profile store 203, a deliverables store 205, a policy store 207, a tailoring engine 107, a tuning engine 109, an SDLC guide module 115, and a CMS store 209. In other embodiments, the SDLC server 110 includes different or additional elements. In addition, the functions may be distributed among the elements in a different manner than described.

The application registration module 101 provides the interface via which a user can submit an application for approval. As described above, the application registration module 101 may provide a web-based interface, an API, or any combination thereof. The application registration module may perform initial eligibility checks, such as confirming that the request comes from an authorized user and that the application is of a type that can be processed by the Digital SDLC system.

The asset store 201 includes one or more non-transitory computer-readable media that store application information such as name, type, owner, and relationship mapping to other dependent application and computer systems. The asset store 201 may be used to register and verify the eligibility of the application submitted using the application registration module 101 by the user. In one embodiment, the eligibility of the registered application is verified over an API by assessing attributes about the application, such as the application name, operational status (e.g., is the application active or retired), application type, and application owner, etc.

The risk profile questionnaire module 103 provides a risk profile questionnaire to users that submit applications for approval. In various embodiments, the risk profile questionnaire collects user input through a displayed series of questions and input fields for the answers. The user may be guided through the questionnaire by tooltips and modal dialogs with additional information about the questions. Additionally or alternatively, calculators can be provided for more complex questions, allowing the user to reach the correct answer easily. Validation logic may be applied to ensure the questionnaire is filled in correctly.

In one embodiment, risk profile questionnaire includes questions to obtain one or more of the following seven attributes:
1) Good Practice (GxP) Regulation: Determines whether the application is regulated by GxP health authorities. More specifically, a GxP determination calculator may be used to suggest the regulatory classification—GMP, GCP, GLP, or other GxP. The calculator uses regulatory statements uniquely designed for the system to confirm the GxP regulation classification for the application.
2) Non-GxP Regulation: Identifies any non-GxP specific regulations (PCI, SOX, or other) that apply to the application.
3) Application Type: determine the configuration of the application as Software-as-a-Service (SaaS), Infrastructure, Commercial/Configurable-Off-the-Shelf (COTS), or Custom built. For COTS applications, the system may also determine whether it is specifically used in laboratory settings.
4) Business Impact: Assessing the impact on the company if the application were to become unavailable, such as classifying it as Business Critical, Core Services, Mission Critical, Business Supporting, or Business Essential, etc. A business impact calculator may be used to help the user choose the correct option. The calculator may use five attributes with four values, each weighted equally in ascending order, such as Penalties and Fines, Direct Revenue, Employee Productivity, Reputation, and Regulatory Compliance.
5) Data Migration: Determine if there are plans for migrating data from a legacy application.
6) Custom Code: Identify whether the application includes any internally developed or vendor-developed custom code.
7) Data Privacy Classification: Determines if the application processes or stores personal information.

The user may be prompted to directly provide these attributes or may be asked more general questions, the answer to which the risk profile questionnaire module 103 analyzes heuristically to determine the relevant attributes. In some instances, the risk profile questionnaire module 103 may make both approaches available such that experienced users can simply provide the relevant attributed whereas less experienced users can answer a set of questions that enable the system to determine the appropriate attributes.

The answers provided in response to the risk profile questionnaire (or the determined attributes) are used as input for a first level calculation by the profiling engine 105 to determine the risk level and intended use of the application. In one embodiment, the outcome of a first level calculation by the profiling engine 105 is translated to risk attributes, stored in the risk profile store 203 (which is one or more non-transitory computer-readable media that store the determined risk attributes).

The SDLC server 110 also includes a policy store 207 that includes one or more non-transitory computer-readable media that store logic and sets of definitions for SDLC activities based on internal policies and external regulations. These are then used to generate deliverables for the user (e.g., stored in a deliverables store 205). In one embodiment, the deliverables store 205 includes one more non-transitory computer-readable media that store SDLC deliverables, SDLC phases, SDLC deliverable sets, and mapping between them as well as information about approvers and owners for each deliverable. Logic may be determined by risk filters based on the output from the risk profile module 103.

The output from the profiling engine 105 is used as input for a second level calculation by the tailoring engine 107. In one embodiment, the tailoring engine 107 uses data from the risk profile store 203 and policy store 207 to predict an ordered list of SDLC deliverables. The tailoring engine 107 may select the deliverables set from the policy store 207 using a rules-based algorithm. The tailoring engine 107 determines the predicted set of deliverables based on policy rules, the risk profile, and deliverables with an indication weight. In one embodiment, the indication weight is an adaptive weighting process that dynamically modifies or generates the weights assigned to deliverables based on internal policy rules and regulatory updates. For example, if a new policy or regulatory change emphasizes data integrity in computer systems, the system automatically increases the weight assigned to the related deliverables in the deliverable set. Conversely, activities deemed less critical under current policy may be assigned a reduced weight. This ensures that the right set of deliverables in the deliverable set is prioritized and aligned with the policy and regulations. A crawler may be used to continuously monitor for policy changes and ingest updates that impact the weight of deliverables. Analytical techniques can be applied to the updates to parse text and automatically extract relevant updates that influence the weights.

Regardless of exactly how the weights are determined, the ordered list of deliverables is generated based on the weights. In one embodiment, this is done by attributing a weight to each deliverable in a deliverable set and following the following steps:
1) The deliverable sets are sorted in descending order based on weight.
2) For each deliverable set, the criteria of the set are compared with the risk profile.
3) If there is a match found between the deliverable set's criteria and the risk profile, that deliverable set is selected.
4) If no matches are found, the algorithm moves on to the next deliverable set.
5) If no matches are found for any deliverable sets, the algorithm selects the one with the lowest weight (i.e., a default deliverable set) without evaluating its criteria.

In one embodiment, the tailoring engine 107 calls a function that is applied to the risk profile attributes to evaluate a series of conditions that check for specific attributes. If there is a match in a threshold number of (e.g., all) conditions, a deliverable set name is returned. If not, the next condition is evaluated. If all conditions are negative, the default deliverable set is returned. The returned deliverable set lists all possible deliverables for the application from the policy store 207. This may be done by the tailoring engine 107 by querying the policy store 207 to get the ordered list of deliverables with deliverable names in machine-readable format. The list of deliverables may also identify one or more of approver units, owner units, an order value, or labels indicating if deliverables are always required.

The system may perform a third calculation using the tuning engine 109. In one embodiment, the tuning engine 109 uses the output of the ordered list of SDLC deliverables as well as additional logic from the risk profile store 203, deliverables store 205, and policy store 207 to map owners and approvers of each SDLC deliverable and adds extra SDLC deliverables to the list that are not specific to a deliverable set. From the policy store 207 and risk profile store 203, filtering is used to narrow down the predicted ordered list of SDLC deliverables from the tailoring engine 107. For each deliverable, the predefined policy store condition determines, based on the risk profile attributes, whether it should stay on the list or not. This shortens the list of deliverables. Based on the attributes from risk profile store 203, applicability of the deliverables is determined. The result of this is specific information, whether each deliverable is to-be-done by the user (applicable) or not-to-be-done (not applicable). The list of SDLC deliverables stays the same length. The policy store 207 and the risk profile store 203 can be used to assign accountability of specific roles for each SDLC deliverable. Additional approvers and owners are added to deliverables according to policy store 207 definitions. Furthermore, from the deliverables store 205, parameters (e.g., the applicability, supporting information, and approvers for a deliverable) can be inherited from a previous version of the deliverable. Moreover, the policy store 207 can include definitions of which deliverables can inherit properties (or which properties can be inherited for a deliverable).

The tuning engine 109 adapts the generated list of deliverables to the preferences of the user and any adjustments made by the user. In one embodiment, the tuning engine 109 applies appropriate applicability, supporting information, and approvers based on user preferences and adjustments. The tuning engine 109 may also use content from the CMS store 209 to rename SDLC deliverables to match a particular deliverable set, as applicable. The CMS store 209 includes one or more non-transitory computer-readable media that store information about appropriate naming conventions for deliverables mapped to different deliverable sets. The CMS store 209 may include key-value-pairs of language keys with texts where a key is a deliverables alias and is used to retrieve the content of the guide page (value).

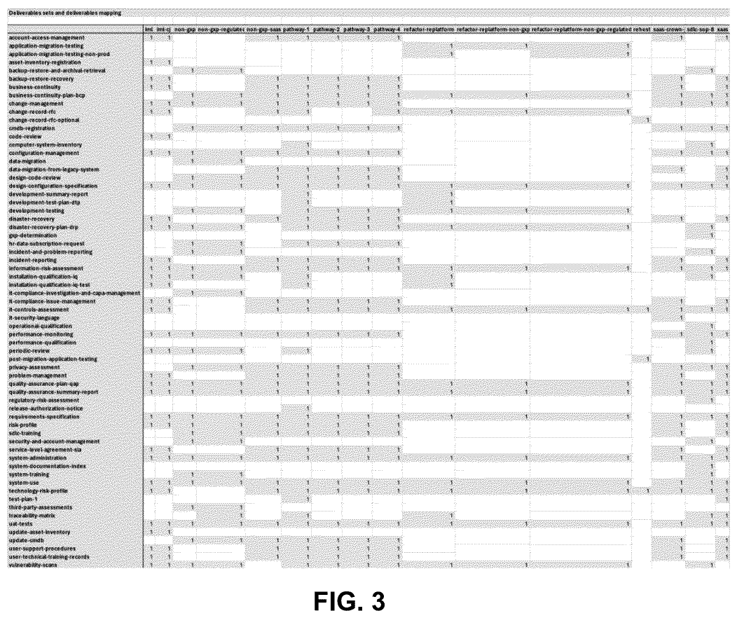

FIG. 3 illustrates an example list of deliverables. In one embodiment, the system displays a user interface to the user (e.g., at an SDLC client device 120 via a web-based interface) that includes a formatted table that identifies the applicable SDLC deliverables. The deliverables may be sorted by SDLC phases when the activity should be completed, who should complete each activity, whether approval is required, the type of approval that should be applied, and a filtered status.

Referring back to FIG. 2, the SDLC guide module 115 generates a guide for the user about an application being evaluated. Information in the guide may include a title, subtitle, alias, description, last reviewed information, related control statements, or any other relevant information about the application that may be useful to the user in completing the SDLC process. The guide may also identify relevant policies, including a title, URL, related guide page, etc. The guide may further include a navigation tree including a title and links to relevant portions of the guide, etc. The SDLC guide enables the translation of intricate regulatory policy language into human-readable, common, easily understandable format, ensuring accessibility and usability. By structuring content based on what, how, and when to do tasks, and organizing topics into categories, users can efficiently access the right information at the right time. The SDLC guide may display a large amount of static content to the user, from detailed “how to” pages describing SDLC deliverables, to pop-up help text to guide users through the application user interface.

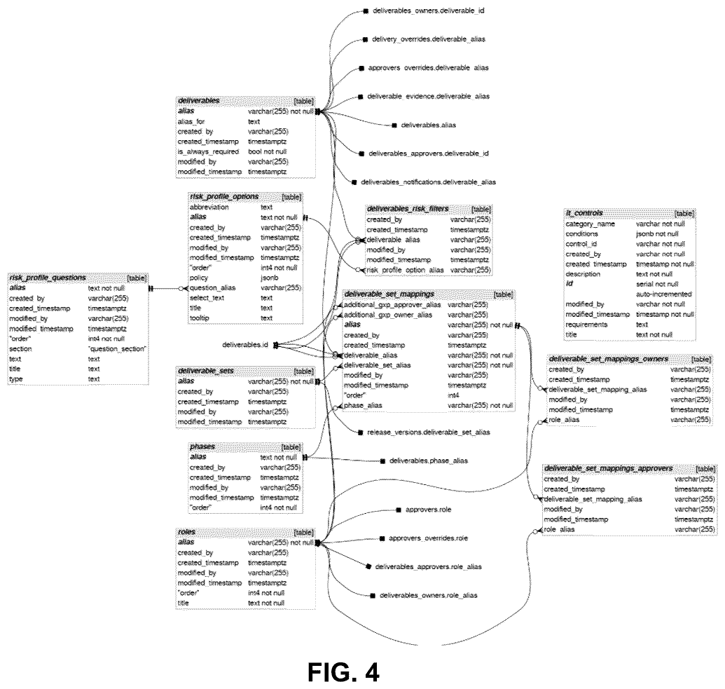

FIG. 4 shows an example for the policy store 207 database schema flow. In the example shown, there is an entity relationship of the policy schema with tables used to query a list of deliverables with related information (roles, approvers, owners, phases), based on deliverable set generated from the tailoring engine 107 during tailoring process. Other relationships may also be defined for the deliverables store 205 to confirm the data integrity and accuracy of the related information according to the information stored in the policy store 207.

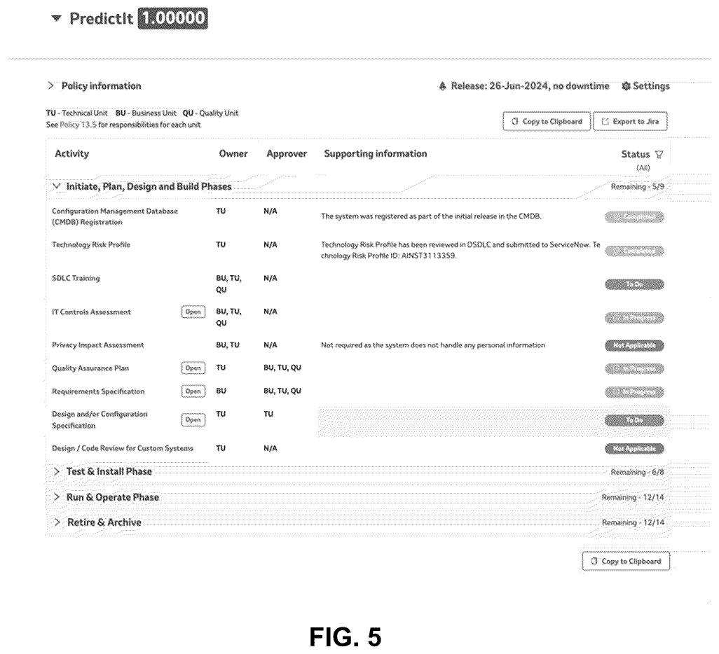

FIG. 5 shows an example user interface showing a Digital SDLC table of deliverables. In the example shown, the table includes a list of deliverables and a status of each (e.g., completed, in progress, to do, or not applicable). The table can also indicate one or more entities (e.g., business units or individuals) who have ownership of completing each deliverable. Similarly, the table can indicate one or more entities who have to approve the particular deliverable. The deliverables can be grouped into categories that can be expanded and collapsed to enable easy review of the current status of the SDLC process.

In some embodiments, once required documents are submitted, the SDLC server 110 validates that the meet the requirements of the corresponding deliverable. This process may be fully automated (e.g., using artificial intelligence such as heuristics or one or more trained models, etc. to verify that the submitted documents meet one or more requirements for the corresponding deliverable), manual (e.g., by notifying the relevant individuals that documents have been submitted and receiving approval from those individuals), or use a mixture of both approaches (e.g., automatically verifying most documents put providing high-priority documents to a user for human confirmation).

Once the requirements of all of the deliverables have been met for an application, the SDLC server 110 may make the application available within the networked computing environment. In one embodiment, a verified application (i.e., one for which the requirements of all deliverables have been met) is made available for installation on enterprise devices 140 in an application library that may be accessed by users. Additionally or alternatively, the verified application may be automatically installed one enterprise devices 140 that meet one or more requirements. For example, if a newly verified application is intended to replace an earlier application, the newly verified application may be automatically installed on enterprises device 140 on which the earlier application is installed.

### Computing System Architecture

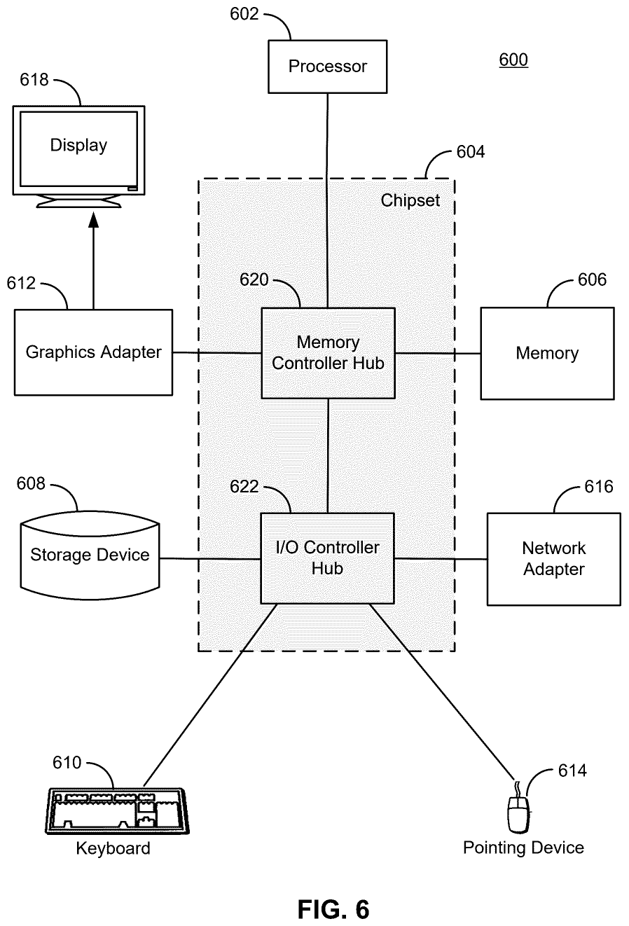

FIG. 6 is a block diagram of an example computer 600 suitable for use as a SDLC server 110, SDLC client 120, third-party server 130, or enterprise device 140. The example computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touchscreen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 170.

The types of computers used by the entities of FIGS. 1 and 2 can vary depending upon the embodiment and the processing power required by the entity. For example, the SDLC server 120 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method of approving an application for deployment, the method comprising:
receiving an approval request for the application;
determining a risk profile for the application based on user responses to a questionnaire;
selecting a set of deliverables from a plurality of possible deliverable sets based on the risk profile;
tuning the set of deliverables based on a policy; and
providing the tuned set of deliverables for display to the user.

2. The computer-implemented method of claim 1, wherein the set of deliverables are selected based on an order of the possible deliverable sets determined from corresponding weightings.

3. The computer-implemented method of claim 2, wherein selecting the set of deliverables comprises:
sorting the plurality of possible deliverables sets in the order based on the corresponding weights;
comparing criteria of a first possible deliverable set in the order to the risk profile;
responsive to a match between the first possible deliverable set and the risk profile, selecting the first possible deliverable set; and
responsive to no match being identified, moving onto a next possible deliverable set in the order.

4. The computer-implemented method of claim 3, wherein selecting the set of deliverables further comprises, responsive to no matches being found for any of the possible deliverable sets, selecting a possible deliverable set with a lowest weight.

5. The computer-implemented method of claim 4, wherein the weights are dynamically determined based on one or more policies, the one or more policies being generated automatically based on parsing of text relating to regulatory requirements.

6. The computer-implemented method of claim 1, further comprising performing validation on the approval request.

7. The computer-implemented method of claim 1, wherein the questionnaire includes questions to establish one or more of: a good practice (GxP) regulatory classification for the application, a non-GxP regulatory classification for the application, a type of the application, a business impact of the application, whether the application will migrate data from a legacy application, whether the application includes custom code, or a data privacy classification for the application.

8. The computer-implemented method of claim 1, further comprising providing a user guide for display, the user guide providing information regarding how to meet one or more deliverables in the tuned set of deliverables and one or more links to regulatory information related to the tuned set of deliverables.

9. The computer-implemented method of claim 1, further comprising:
causing display of status information for at least some of the tuned set of deliverables, the status information indicating progress towards completion of requirements of the tuned set of deliverables and entities responsible for approving deliverables.

10. The computer-implemented method of claim 1, further comprising:
determining whether all requirements of the tuned set of deliverables have been met; and
responsive to all requirements of the tuned set of deliverables having been met, making the application available for deployment.

11. A non-transitory computer-readable medium comprising stored instructions for approving an application for deployment, the instructions, when execute, causing a computing system to:
receive an approval request for the application;
determine a risk profile for the application based on user responses to a questionnaire;
select a set of deliverables from a plurality of possible deliverable sets based on the risk profile;
tune the set of deliverables based on a policy; and
provide the tuned set of deliverables for display to the user.

12. The non-transitory computer-readable medium of claim 11, wherein the set of deliverables are selected based on an order of the possible deliverable sets determined from corresponding weightings.

13. The non-transitory computer-readable medium of claim 12, wherein the instructions that cause the computing system to select the set of deliverables comprise instructions that cause the computing system to:
sort the plurality of possible deliverables sets in the order based on the corresponding weights;
compare criteria of a first possible deliverable set in the order to the risk profile;
responsive to a match between the first possible deliverable set and the risk profile, select the first possible deliverable set;
responsive to no match being identified, move onto a next possible deliverable set in the order; and
responsive to no matches being found for any of the possible deliverable sets, select a possible deliverable set with a lowest weight.

14. The non-transitory computer-readable medium of claim 13, wherein the weights are dynamically determined based on one or more policies, the one or more policies being generated automatically based on parsing of text relating to regulatory requirements.

15. The non-transitory computer-readable medium of claim 11, wherein the instructions further cause the computing system to perform validation on the approval request.

16. The non-transitory computer-readable medium of claim 11, wherein the questionnaire includes questions to establish one or more of: a good practice (GxP) regulatory classification for the application, a non-GxP regulatory classification for the application, a type of the application, a business impact of the application, whether the application will migrate data from a legacy application, whether the application includes custom code, or a data privacy classification for the application.

17. The non-transitory computer-readable medium of claim 11, wherein the instructions further cause the computing system to provide a user guide for display, the user guide providing information regarding how to meet one or more deliverables in the tuned set of deliverables and one or more links to regulatory information related to the tuned set of deliverables.

18. The non-transitory computer-readable medium of claim 11, wherein the instructions further cause the computing system to:
cause display of status information for at least some of the tuned set of deliverables, the status information indicating progress towards completion of requirements of the tuned set of deliverables and entities responsible for approving deliverables.

19. The non-transitory computer-readable medium of claim 11, wherein the instructions further cause the computing system to:
determine whether all requirements of the tuned set of deliverables have been met; and
responsive to all requirements of the tuned set of deliverables having been met, make the application available for deployment.

20. A computing system comprising:
one or processors; and
one or more memories storing instructions that, when executed by the one or more processors, cause the computing system to:
receive an approval request for the application;
determine a risk profile for the application based on user responses to a questionnaire;
select a set of deliverables from a plurality of possible deliverable sets based on the risk profile;
tune the set of deliverables based on a policy; and
provide the tuned set of deliverables for display to the user.
